(19) United States
(12) Patent Application Publication
(10) Pub. No.: US 2008/0226263 A1
(43) Pub. Date: Sep. 18, 2008

(54) Digest Watching System, and Reproduction Controlling Apparatus for Digest Watching

(75) Inventors: Reiji Iwase, Tokyo (JP); Toshiaki Tsuchiya, Tokyo (JP); Hiyroyuki Kamijo, Tokyo (JP); Kenichi Kita, Tokyo (JP)

Correspondence Address: NIXON & VANDERHYE, PC, 901 NORTH GLEBE ROAD, 11TH FLOOR, ARLINGTON, VA, 22203, US

(73) Assignee: PIONEER CORPORATION, Tokyo (JP)

(21) Appl. No.: 11/887,274

(22) PCT Filed: Mar. 27, 2006
(86) PCT No.: PCT/JP2006/306177

§ 371 Date: Dec. 17, 2007

(30) Foreign Application Priority Data
Mar. 28, 2005 (JP) 2005-091886

(51) Int. Cl. H04N 7/26

(52) U.S. Cl. 386/124

(57) ABSTRACT

A digest view system includes an information providing server and a recording/reproducing device. The information providing server includes a segment information DB for storing segment information for identifying segments contained in the content digest. When performing a digest view, the recording/reproducing device acquires the segment information and creates digest data on the content recorded. In the recording/reproducing device, the digest data is corrected according to view support information for inserting an explanation screen acquired from the view support information DB of the information providing server, thus improving the quality of view of the segment contained in the digest.

### TECHNICAL FIELD

The present invention relates to a digest watching system for watching a digest of content, and a reproduction controlling apparatus for digest watching.

### BACKGROUND ART

As this type of system, there has been proposed a system in which reproduction support information is supplied from the exterior (e.g. refer to a patent document 1).

According to an information reproduction control system disclosed in the patent document 11 (hereinafter referred to a “conventional technology”), the reproduction of video data can be controlled on the basis of the reproduction support information, which is supplied from the exterior, so that a user can easily understand the substance or content of the video data and perform digesting.
Patent document 1: Japanese Patent Application Laid Open NO. 2001-54071

### DISCLOSURE OF INVENTION

### Subject to be Solved by the Invention

During the digesting, screens are frequently changed. In the conventional technology, although the user can understand the substance or content of the video data in advance by using the reproduction support information, the user only watches video images in which pieces of the video data are merely connected. That is, the conventional technology has such a technical problem that high-quality digesting is hardly performed.

In view of the aforementioned problem, it is therefore an object of the present invention to provide a digest watching system and a reproduction controlling apparatus for digest watching, which allow the high-quality digesting.

### Means for Solving the Subject

### <Digest Watching System>

The above object of the present invention can be achieved by a digest watching system provided with: a server apparatus; and a reproduction controlling apparatus, which are both included in a network, the server apparatus provided with: a first memory device for storing specification data, which is to specify segments corresponding to a keyword which is set in advance in content including at least a video image, in association with the keyword; a second memory device for storing support data, which is to support watching of at least one portion of the segments corresponding to the keyword, in association with the at least one portion of the segments; a selecting device for selecting, in accordance with an entry which indicates the specification of at least one of the content and the keyword, the specification data and the support data which correspond to the specified at least one of the content and the keyword; and a first communicating device for transmitting the selected specification data and the selected support data to the reproduction controlling apparatus through the network, the reproduction controlling apparatus provided with: a third memory device for storing the content; a second communicating device for receiving the transmitted specification data and the transmitted support data through the network; a digest data generating device for generating digest data which is to generate a digest of the content in which the segments corresponding to the keyword, which are specified by the received specification data, are arranged in time series, out of the stored content; a digest data correcting device for correcting at least one portion of the digest data on the basis of the received support data; and a reproducing device for reproducing the digest which is corrected, on the basis of the corrected digest data.

The digest watching system of the present invention is provided with: the server apparatus; and the reproduction controlling apparatus, which are both included in the network.

The “network” in the present invention is a wide area network, represented by the Internet environment or the like, which uses a general phone line, a CATV network, an ADSL (Asymmetric Digital Subscriber Line), an optical fiber, or the like. Alternatively, it may be a LAN (Local Area Network) or a WAN (Wide Area Network), which is established on the basis of the Ethernet (register mark) standard or the like. Alternatively, it may be a network which can be connected to the Internet through the aforementioned networks.

In the digest watching system of the present invention, the server apparatus conceptually includes a work station, a personal computer, or a computer system which conforms thereto The server apparatus is provided with the first memory device in which the specification data, which is to specify the segments corresponding to the keyword which is set in advance in the content including at least the video image, are stored in association with the keyword. Incidentally, the aspect of the first memory device is not limited as long as it can be used in a computer system as being the server apparatus. For example, it may be various recording media, such as a HD (Hard Disk), a DVD, a CD-ROM, and a CD-RW.

Here, the “content including at least the video image” indicates content or contents (or broadcast programs) of various television broadcasts, such as analog or digital terrestrial broadcast, analog or digital satellite broadcast and cable television broadcast. The genre of the content is not limited as long as the content includes the video image. For example, the genre can employ various aspects, such as drama, news, variety, sports, and documentary. Therefore, preferably, the content includes not only the video image but also a sound corresponding to the video image. If the content is such a broadcast program, the content is supplied from a predetermined broadcast station as various aspects of a broadcast wave or a broadcast signal. The broadcast wave or the broadcast signal is received by an antenna, a cable, or the like. Incidentally, the server apparatus may be unified with the broadcast station. In other words, the content may be supplied from the server apparatus. Moreover, in the digest watching system of the present invention, the aspect of supplying the content is not limited to this. For example, the content may be supplied by streaming, downloading, or the like through the network. Alternatively, the content may be supplied in such a form that the content is recorded on some recording medium.

The “segment” of the present invention conceptually indicates one portion of the content. For example, if the content is a drama, the segment indicates one scene, one cut, or one shot in which a particular actor appears. That is, the segment is defined in view of the substance of the content, as occasion demands, rather than being defined on the basis of physical conditions, such as a data size. Therefore, the “segments corresponding to the keyword which is set in advance” conceptually include particular portions which are associated by some keyword in the content. For example, in the content, such as a sports program, if the keyword is “a player so-and-so”, all the video images including the player so-and-so can be the segments corresponding to the keyword. Incidentally, the keyword is not limited to humans, animals, backgrounds, or the like, as long as it can specify the segments corresponding thereto from the content.

The specification data for specifying the segments corresponding to the keyword is not limited as long as it can define relative positions of the segments in the content, such as the start time point, end time point, time length, start data position, end data position, and data length of the segments Alternatively, these may be attended with data which defines the substance and attribute of the segments.

Incidentally, the specification data may be generated in arbitrary ways. For example, if the content is supplied from a broadcast station, the broadcast station that broadcasts the content may supply the specification data related to the server apparatus through the network of the present invention. Moreover, the specification data may be supplied by transmitting it with it superimposed on a broadcast signal or a broadcast wave without through the network. Alternatively, the specification data may be generated on the server apparatus side, on the basis of some data which is supplied from a broadcast station. Moreover, if the specification data is generated on the server apparatus side, it may be generated through various input equipment, such as a keyboard, a mouse, a touch pad, and a scroll button, or one portion or all of the specification data may be automatically generated. If it is automatically generated, for example, if the keyword includes informations about a human, the specification data may be generated on the basis of various known recognition techniques, such as image recognition and facial recognition.

Moreover, a plurality of keywords may be provided for one content. In this case, if the specification data is supplied from a broadcast station, the keywords may be uniquely determined on the broadcast station side, or it may be sequentially determined or expanded in response to some request. If the specification data is generated on the server apparatus side, the keywords may be uniquely determined on the server apparatus side. Of course, the specification data is assigned to each of the keywords. On the first memory device, the specification data is stored in association with the keyword. Therefore, on the server apparatus, the first memory device may function as a database.

Moreover, the server apparatus has the second memory device in which the support data, which is to support the watching of at least one portion of the segments corresponding to the keyword, is stored in association with the at least one portion of the segments.

Here, the “support data” of the present invention is data for supporting the watching of at least one portion of the segments corresponding to the keyword. The aspect of the support is not limited as long as the segments are watched somewhat smoothly and comfortably, compared with the case that no support is given. The aspect of the support data may be determined, as occasion demands, depending on the substance or content of the support. For example, it may be video data, HTML (Hyper Text Markup Language) data, BML (Broadcast Markup Language) data, text data, or the like. Moreover, the support data may include information which specifies each of display timing, a display period, a display position, size, font, a display color, and the like. The support data is stored on the second memory device in association with the segment which is the support target.

Incidentally, the aspect of the second memory device is not limited as long as it can be used by a computer system as being the server apparatus. For example, it may be various recording media, such as a HD (Hard disk), a DVD, a CD-ROM, and a CD-RAM. Moreover, the first memory device and the second memory device may be constructed as one hardware.

On the server apparatus, by virtue of the selecting device, the specification data and the support data, which correspond to at least one of the content and the keyword, are selected in accordance with the entry which indicates that the at least one of the content and the keyword is specified.

The “entry” herein indicates an instruction which is artificially made through various input equipment, such as a keyboard, a mouse, and an operation button. Alternatively, it is not limited to the artificial instruction, and it may be an instruction which is automatically given by some controller and control equipment when a predetermined condition is satisfied. For example, an entry which is artificially made through a remote controller, an operation panel, or input equipment which conforms thereto, on the reproduction controlling apparatus may be treated as the “entry” through the network. Alternatively, a trigger signal may be treated as the entry wherein the trigger signal is outputted in each predetermined timing on a broadcast station and on the server apparatus side. In this case, the data about the content and the keyword, which are determined on the server apparatus side, may be transmitted to an unspecified number of reproduction controlling apparatuses through the network. Incidentally, the “at least one of the content and the keyword” indicates that the specification data and the support data which are requested may be arbitrarily determined. For example, if only the content is specified, the specification data and the support data may be selected for all the keywords which are set in advance with regard to the content. Moreover, if the content and the keyword are specified, only the specification data and the support data which correspond to the specified keyword may be selected. Alternatively, if only the keyword is specified, the specification data and the support data which correspond to the keyword may be selected for a plurality of contents. If the specification data and the support data are selected, these data are transmitted to the reproduction controlling apparatus through the network.

Incidentally, here, the specification data and the support data are not necessarily transmitted at the same time or in response to the same entry. For example, only the specification data may be firstly transmitted, and the support data may be transmitted only if it is requested to transmit the support data by a user of the reproduction controlling apparatus.

The reproduction controlling apparatus of the present invention is provided with the third memory device in which the content or contents of the present invention are stored. Here, the content may be a broadcast program which is recorded by the reproduction controlling apparatus and which is stored as record data on the third memory device if the reproduction controlling apparatus is provided with a recording function. Moreover, it may be some content which is downloaded through the network, or it may be content which is supplied through a recording medium and which has transportability. Incidentally, the content which has transportability may be, for example, a DVD, a BRD (Blue Ray Disc), a CD-ROM, or the like. Moreover, the aspect of the third memory device is not limited as long as it can store the content. For example, it may be various recording media, such as a HD, a DVD, and a CD-ROM, and drive apparatuses corresponding thereto. Incidentally, the third memory device of the present invention may have such a structure that a drive apparatus and a recording medium are independent of each other, like a DVD, a CD, or the like. Alternatively, the third memory device may have such a structure that the third memory device and a drive apparatus make a pair, like a HDD. Therefore, the reproduction controlling apparatus of the present invention can employ various aspects, such as a television apparatus equipped with a HDD, a DVD recording apparatus, a HDD recording apparatus, and various set top boxes (STB).

On the reproduction controlling apparatus, the digest data generating device generates the digest data on the basis of the specification data, which is transmitted from the server apparatus.

Here, the “digest data” of the present invention indicates data for reproducing the digest which mainly includes the segments corresponding to one keyword out of the content stored on the third memory device, and preferably, which is entirely provided with the segments corresponding to one keyword.

The occurrence frequency and the ratio of the segments corresponding to one keyword vary depending on the content. Moreover, even in the same content, the occurrence frequency and the ratio vary depending on the keyword. Therefore, the substance or content of the digest may be arbitrarily determined without any limitation.

In the digest of the present invention, the segments corresponding to the keyword are arranged in time series. Here, “being arranged in time series” means that each segment is sequentially reproduced. Therefore, it is not necessary to follow the time series of the original content. For example, portions of respective segments included in the digest are displayed collectively or continuously in indeterminate order, and then each of the segments may be displayed in the order that follows the time series of the original content.

In particular, if the segments corresponding to the keyword are merely arranged, it is hard to perform the digest watching in high quality, as in the conventional technology. Therefore, in the digest watching system of the present invention, the digest data correcting device corrects the digest data on the basis of the support data transmitted from the server apparatus, to thereby solve the problem.

The correction performed by the digest data correcting device is to allow a user to watch the digest, smoothly or comfortably, in view of the aforementioned concept of the support data. For example, if the support data is video data, the digest data may be corrected so as to insert the video data in the digest. In this case, in the digest, it may be inserted as another segment, or it may be inserted so as to superimpose it as a video image on the video image of some segment. For example, the video image inserted in this manner may be some information about the segment which is being reproduced at a current time point. Moreover, the correction is not limited to using the video data, and the digest data may be arbitrarily corrected in accordance with various aspects of the support data, such as HTML data, BML data, and text data, described above, as long as it can improve the quality of the digest.

The reproducing device reproduces the corrected digest in accordance with the digest data corrected in this manner. Incidentally, here, “reproduce” indicates performing a process for displaying on a predetermined displaying device. Therefore, the reproduction controlling apparatus may not be provided with the displaying device.

As described above, according to the digest watching system of the present invention, the digest is not generated merely as cut-and-paste segments, and information can be flexibly inserted into the digest in accordance with the aspect of the support data. Therefore, it is possible to perform the high-quality digest watching.

Incidentally, one portion or all of the specification data and the support data, which are received on the reproduction controlling apparatus, and the digest data and the corrected digest data, which are generated on the reproduction controlling apparatus, may be stored into the third memory device in which the content is stored, or some memory device which is different from the third memory device. In this case, once these data are received or generated, the digest about some keyword in some content can be watched anytime in desired timing, so it is preferable. Alternatively, the digest watching can be easily performed, so it is preferable.

Moreover, it is also possible and easy to access the server apparatus in desired timing through a remote controller, various operation panels or the like, which is provided for the reproduction controlling apparatus. In this case, desired content may be selected from the content or contents stored on the third memory device, and an entry which specifies the content may be made Moreover, in response to this, list data may be transmitted to the reproduction controlling apparatus, wherein the list data is to display a list of the keyword or keywords, which are set for the specified content on the server apparatus side, on the displaying device mounted on the reproduction controlling apparatus. On the reproduction controlling apparatus, for example, a user may select a desired keyword from the list and make the entry again which indicates that the keyword is selected. On the basis of the entry, the server apparatus may transmit the specification data and the support data which correspond to the specified keyword to the reproduction controlling apparatus. In this manner, a communication is made between the server apparatus and the reproduction controlling apparatus, as occasion demands, to thereby maintain the high-quality digest watching.

In one aspect of the digest watching system of the present invention, the support data includes data which defines an imposed video image to be imposed on the at least one portion of the segments, and the digest data correcting device corrects the digest data so as to impose the imposed video image on the at least one portion of the segments, in the corrected digest, on the basis of the data which defines the imposed video image.

Here, “impose” conceptually indicates that information is superimposed on one screen in one segment. Therefore, the imposed video image is a video image in which the segment watching is supported by the imposition, and if the content is a sports program, the imposed video image may be the history of score or data which conforms thereto.

Incidentally, a position on the screen in which the imposed video image is imposed (i.e. imposed position) may be arbitrarily determined as long as the segment display is not obstructed. For example, if the appropriate imposed position can be determined in advance, experimentally, experientially, or by simulations or the like, it may be such a position. Moreover, in some imposed position, the visibility of the imposed video image may deteriorate. In such a case, the display color of the imposed video image may be changed, or the display color of a portion which is overlapped with the imposed video image on the screen may be changed.

According to this aspect, the imposed video image can give an added value to the segments which constitute the digest, and improves the quality of the digest.

In another aspect of the digest watching system of the present invention, the support data includes data which defines an explanatory video image for explaining substance of the at least one portion of the segments, and the digest data correcting device corrects the digest data so as to reproduce the explanatory video image before reproducing the at least one portion of the segments, in the corrected digest, on the basis of the data which defines the explanatory video image.

According to this aspect, the explanatory video image allows the substance or content of one segment to be displayed to a user before the display of the segment, so that it is possible and easy to always accurately understand the substance or content of the segment during the digest watching.

Here, the expression “to reproduce . . . before reproducing” conceptually indicates that the reproduction may be performed in arbitrary timing before the segment which is an explanation target (or explanation-target segment) is reproduced, but preferably, the reproduction is performed between the explanation-target segment and the segment which has been reproduced until immediately before; namely, the reproduction is performed immediately before the explanation-target segment. Incidentally, the “explanatory video image” may be merely a character or text video image which indicates the substance or content of the segment whose display is started from now.

In another aspect of the digest watching system of the present invention, the content includes a sound, the support data includes audio correction data for correcting a sound of the at least one portion of the segments, and the digest data correcting device corrects the digest data so as to correct the sound of the at least one portion of the segments, in the corrected digest, on the basis of the audio correction data.

In the case that the content includes the sound, if the segments are merely connected, the sound is discontinuous in the boundary of the segments, and the quality of the digest easily deteriorates. According to this aspect, the support data includes the audio correction data correcting the sound of the at least one portion of the segments corresponding to the keyword. The digest data correcting device corrects the digest data so as to correct the sound of the at least one portion of the segments, in the corrected digest, on the basis of the audio correction data. Therefore, the quality of the reproduced digest is dramatically improved by reducing, and preferably solving the discontinuity of the sound.

Incidentally, the audio data included in the support data may be data which defines the entire sound of the segment, or data which defines one portion of the sound. In the former case, for example, the digest data may be corrected so as to use the audio data included in the support data without using the audio data of the recorded content or contents (i.e. the content or contents stored on the third memory device), in one portion of the segment which is being reproduced. In the latter case, the digest data may be corrected so as to literally support one portion of the audio data of the recorded content or contents.

Incidentally, the audio correction data may be data for combining the cheers or applause of audiences, live sounds in a place, voices of players, or the like with one portion of the segments in order to create a sense of reality or alive in the place, in the content such as a sports program. Moreover, if one portion of a series of sounds corresponding to the segments included in the digest in the content ranges over the segment which is not included in the digest, the audio correction data may be the audio data which is extracted from the segment which is not included in the digest.

### <Reproduction Controlling Apparatus for Digest Watching>

The above object of the present invention can be also achieved by a reproduction controlling apparatus for digest watching, capable of communicating through a network with a server apparatus provided with: a first memory device for storing specification data, which is to specie segments corresponding to a keyword which is set in advance in content including at least a video image, in association with the keyword; a second memory device for storing support data, which is to support watching of at least one portion of the segments corresponding to the keyword, in association with the at least one portion of the segments; a selecting device for selecting the specification data and the support data which correspond to at least one of the content and the keyword which is specified, in accordance with an entry which indicates the specification of at least one of the content and the keyword; and a first communicating device for transmitting the selected specification data and the selected support data to the reproduction controlling apparatus through the network, the reproduction controlling apparatus provided with: a third memory device for storing the content; a second communicating device for receiving the transmitted specification data and the transmitted support data through the network; a digest data generating device for generating digest data which is to generate a digest of the content in which the segments corresponding to the keyword, which are specified by the received specification data, are arranged in time series, out of the stored content; a digest data correcting device for correcting at least one portion of the digest data on the basis of the received support data; and a reproducing device for reproducing the digest which is corrected, on the basis of the corrected digest data.

According to the reproduction controlling apparatus for digest watching of the present invention, it allows the high-quality digest watching because of the operation of each of the devices which is the same as that in the reproduction controlling apparatus in the digest watching system of the present invention described above.

As explained above, the digest watching system of the present invention includes the server apparatus and the reproduction controlling apparatus, wherein the server apparatus is provided with the first memory device, the second memory device, the selecting device, and the first communicating device, and the reproduction controlling apparatus is provided with the third memory device, the second communicating device, the digest data generating device, the digest data correcting device, and the reproducing device. Thus, it allows the high-quality digest watching. As explained above, the reproduction controlling apparatus for digest watching is provided with the third memory device, the second communicating device, the digest data generating device, the digest data correcting device, and the reproducing device. Thus, it allows the high-quality digest watching.

These effects and other advantages of the present invention will become more apparent from the embodiment explained below.

### BRIEF DESCRIPTION OF DRAWINGS

FIG. 1 is a conceptual view showing a digest watching system in an embodiment of the present invention.

FIG. 2 is a block diagram showing an information providing server in the system in FIG. 1.

FIG. 3 are schematic diagrams showing segment information on the information providing server in FIG. 2.

FIG. 4 is a block diagram showing a recording/reproducing apparatus in the system in FIG. 1.

FIG. 5 is a flowchart showing a digest watching process performed by the recording/reproducing apparatus in FIG. 4.

FIG. 6 are schematic diagrams showing digest video images which are corrected on the basis of watching support information on the recording/reproducing apparatus in FIG. 4.

FIG. 7 is a conceptual view showing a digest which is corrected on the basis of another watching support information of the present invention.

FIG. 8 are schematic diagrams showing digest video images in the digest in FIG. 7.

FIG. 9 are schematic diagrams showing digest video images which are corrected on the basis of another watching support information of the present invention.

FIG. 10 is a schematic diagrams showing segment change information on the recording/reproducing apparatus in FIG. 4.

FIG. 11 is a schematic diagram showing preference judgment based on a trick play, on the recording/reproducing apparatus in FIG. 4.

### DESCRIPTION OF REFERENCE CODES

10 digest watching system
11 network
100 information providing server
121 segment information database
122 watching support information database
200 recording/reproducing apparatus
211 CPU
230 recording/reproducing device
240 HDD
250 digest data generating device

### BEST MODE FOR CARRYING OUT THE INVENTION

Hereinafter, the best mode for carrying out the present invention will be explained in each embodiment in order with reference to the drawings.

### <Structure of Embodiment>

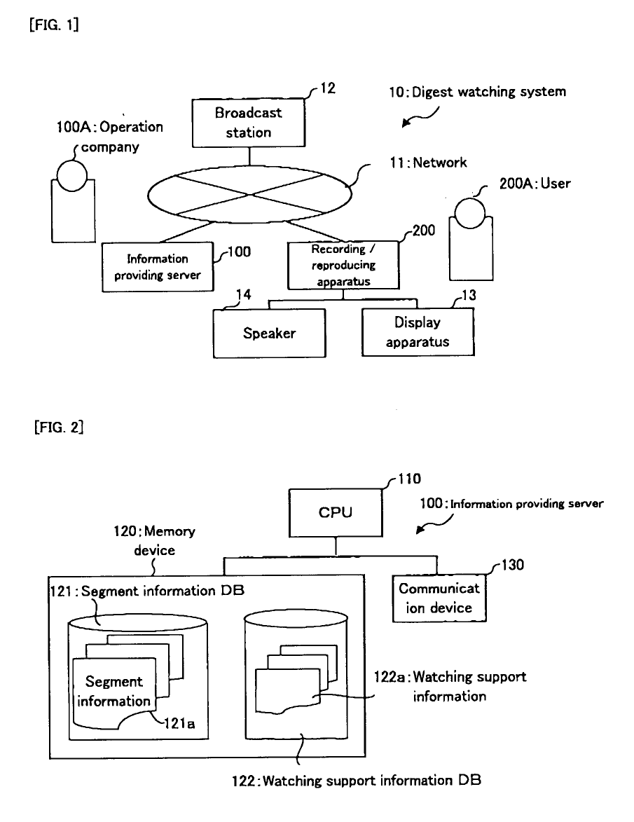

Firstly, with reference to FIG. 1, the structure of a digest watching system in an embodiment of the present invention will be explained. FIG. 1 is a conceptual view showing a digest watching system 10.

In FIG. 1, the digest watching system 10 is provided with: a broadcast station. 12; an information providing server 100; and a recording/reproducing apparatus 200, which are included in a network 11.

The network 11 is a wide area network, represented by the Internet or the like. In the digest watching system 10, the broadcast station 12, the information providing server 100, and the recording/reproducing apparatus 200 are located in different places from each other.

The broadcast station 12 provides a broadcast program, which is one example of the “content” of the present invention, as a broadcast signal through a broadcast wave, which is a different route from the network 11. The broadcast station 12, however, is also included in the network 11 and sequentially provides data about various contents supplied as the broadcast signal, to the information providing server 100.

To the recording/reproducing apparatus 200, a display apparatus 13 and a speaker 14 are further connected. The recording/reproducing apparatus 200 is one example of the “reproduction controlling apparatus” and the “reproduction controlling apparatus for digest watching” of the present invention, which is adapted to receive the broadcast signal through an antenna (not illustrated) or the like from the broadcast station 12 and record it onto a HDD described later. Incidentally, the recording/reproducing apparatus 200, the display apparatus 13, and the speaker 14 are owned by a user 200A.

The information providing server 100 is a computer system run by an operation company 100, and it is one example of the “server apparatus” of the present invention. The information providing server 100 allows members who have paid a predetermined expense to access a site run on the network 11. Incidentally, in the embodiment, the user 200A of the recording/reproducing apparatus 200 is one of the members.

Under such construction, the recording/reproducing apparatus 200 is adapted to allow the user to watch the digest of the recorded content, by using information (or data) provided by the information providing server 100 through the network 11.

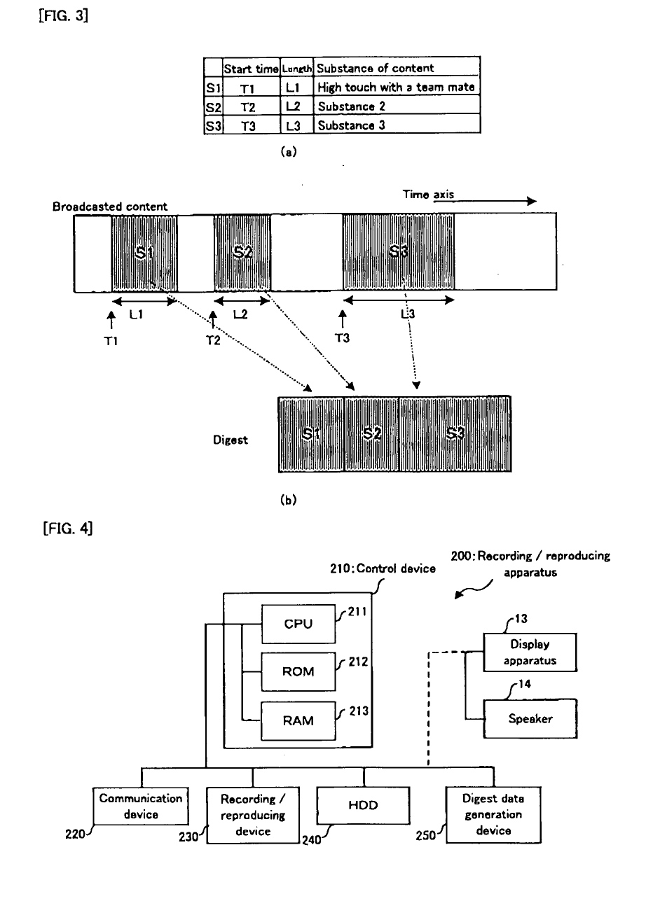

Next, with reference to FIG. 2, the detailed structure of the information providing server 100 will be explained. FIG. 2 is a block diagram showing the information providing server 100.

In FIG. 2, the information providing server 100 is provided with: a CPU (Central Processing Unit) 110; a memory device 120; and a communication device 130.

The CPU 110 is a control unit for controlling the operation of the information providing server 100 and is adapted to function as one example of the “selecting device” of the present invention.

The memory device 120 is provided with a large-capacity recording medium, such as a HDD, and has a segment information database (hereinafter referred to as a “segment information DB”), which is one example of the “first memory device” of the present invention, and a watching support information database (hereinafter referred to as a “watching support information DB”), which is one example of the “second memory device”, within the recording medium.

The segment information DB stores therein a plurality of segment information 121a. The segment information 121a is generated by the operation company 100A for each of contents broadcasted by the broadcast station 12, on the basis of predetermined data which is provided through the network 11. Therefore, the segment information 121a is stored in the segment information DB 121 in such a form that the segment information 121a is associated with each of many contents.

The segment information 121a is data for specifying segments to be included in the digest of the content, and it is one example of the “specification data” of the present invention. Incidentally, the segments to be included in the digest of the content appropriately vary depending on the keyword of the digest. For example, if the content is a drama, a digest with a keyword of “an actor so-and-so” and a digest with a keyword of “an actress so-and-so” are inevitably different. Thus, in the information providing server 100, a plurality of keywords are set for some content, and the segment information 121a is stored in such a form that the segment information 121a is associated with respective one of the set keywords. Therefore, the segment information DB 121 has at least one segment information 121a for each content.

Now, with reference to FIG. 3, the details of the segment information 121a are explained. FIG. 3 are schematic diagrams showing segment information.

In FIG. 3, the segment information 121a is information which indicates the position, length, and content of the segments to be included in the digest of the content (FIG. 3(a)). For example, a segment S1 has a start time point T1 and a length L1, and the content is “high touch with a team mate”. Incidentally, the start time point is not an absolute time point but a relative time point which is expressed as an elapsed time from the start time point of the content. The length is defined by a measure of time, such as second and minute.

Because of the segment information 121a, the digest of the content is as shown in FIG. 3(b). That is, out of the originally broadcasted content, segments S1, S2, and S3 are extracted in accordance with the segment information and arranged in a time-axis direction, i.e. in time series, to thereby construct the digest.

Back in FIG. 2, the watching support information DB 122 stores watching support information 122a. The watching support information 122a is one example of the “support information” of the present invention, which is generated for a segment that is judged to be necessary by the operation company 100A out of the segments included in the digest of the content. The type of the watching support information 122a, the number thereof, and the position in the corresponding segment are not limited and determined in accordance with the content of the digests. Therefore the watching support information 122a is not always generated for all of the segments included in the digest. The generated watching support information 122a is stored into the watching support information DB 122 in such a form that the watching support information 122a is associated with the target segment. This type of association allows easy judgment of whether or not there is a segment corresponding to the watching support information 122a in the segments which are included in one segment information 121a if the one segment information 121a is selected from the segment information DB 121. Incidentally, the details of the watching support information 122a will be described later.

The communication device 130 is one example of the “first communicating device” of the present invention, which is adapted to transmit the segment information 121a and the watching support information 122a to the recording/reproducing apparatus 200 through the network 11 under the control of the CPU 110.

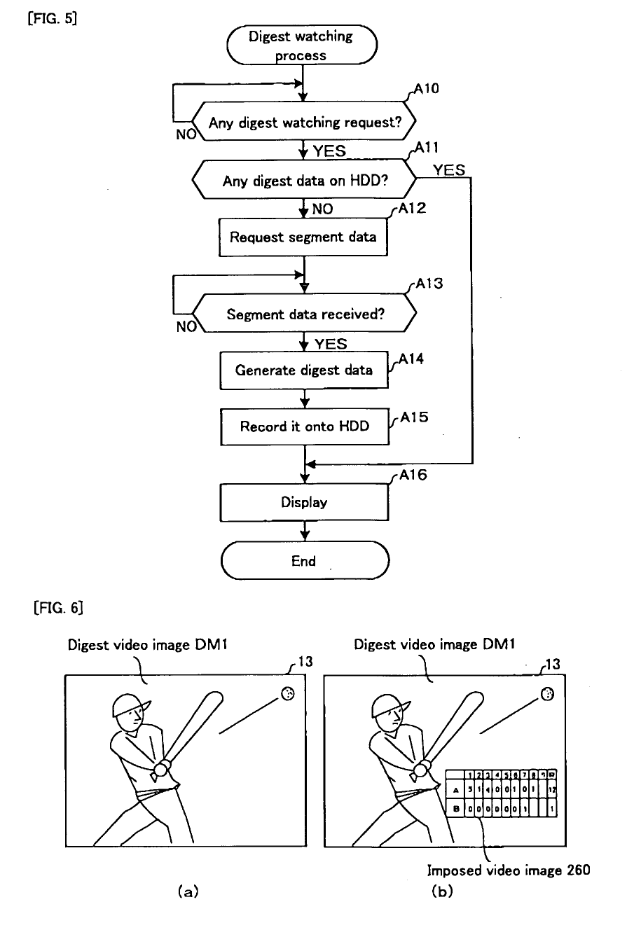

Next, with reference to FIG. 4, the detailed structure of the recording/reproducing apparatus 200 will be explained. FIG. 4 is a block diagram showing the recording/reproducing apparatus 200.

In FIG. 4, the recording/reproducing apparatus 200 is provided with: a control device 210; a communication deice 220; a recording/reproducing device 230; a HDD 240; and a digest data generation device 250.

The control device 210 is provided with: a CPU 211; a ROM (Read Only Memory) 212; and a RAM (Random Access Memory) 213.

The CPU 211 is a control unit for controlling the operation of the recording/reproducing apparatus 200 and constitutes one example of each of the “digest data generating device”, the “digest data correcting device”, and the “reproducing device” of the present invention. The CPU 211 is adapted to reproduce the digest of the recorded content by performing a digest watching process described later.

The ROM 212 is a nonvolatile memory and stores therein a digest watching program. The CPU 211 is adapted to perform a digest watching process by reading this digest watching program from the ROM 212 and executing it.

The RAM 213 is adapted to temporarily store various data which is generated in the procedure that the CPU 211 performs the digest watching process.

The communication device 220 is one example of the “second communicating device” of the present invention, which is adapted to communicate with the information providing server 100 through the network 11.

The recording/reproducing device 230 is adapted to separate the broadcast signal about the content from the broadcast wave received by the not-illustrated antenna and further separate a video signal and an audio signal, to thereby record the signals onto the HDD 240 as digital data in the end. Moreover, the recording/reproducing device 230 is adapted to read the video data of the various contents stored in the HDD to generate the video signal, which can be displayed by the display apparatus 13, and supply it to the display apparatus 13. It is also adapted to read the audio data of the various contents to generate the audio signal, whose sound can be released by the speaker 14, and supply it to the speaker 14. That is, the recording/reproducing device 230 is adapted to function as one example of the “reproducing device” of the present invention, with the CPU 211.

The HDD 240 is a large-capacity memory apparatus with a hard disk as a recording medium, and it is one example of the “third memory device” of the present invention.

The digest data generation device 250 is adapted to generate digest data for reproducing the digests of the various contents stored in the HDD 240, and it is adapted to function as one example of the “digest data generating device” of the present invention, with the CPU 211. Incidentally, the digest data generation device 250 is a unit for generating the video data and the audio data of the digest, as illustrated in FIG. 3(b), and supplying them to the recording/reproducing device 230.

Next, with reference to FIG. 5, the details of the digest watching process will be explained. FIG. 5 is a flowchart showing the digest watching process.

In FIG. 5, the CPU 211 firstly judges whether or not there is a digest watching request (step A10). The digest watching request is judged on the basis of e.g. whether or not there is an entry to request the digest watching of the content recorded on the HDD 240. The entry is made by the user 200A or the like, through a predetermined inputting device, e.g. an operation button of an operation panel and a remote controller terminal of the recording/reproducing apparatus. If there is no digest watching request (the step A10: NO), the CPU 211 stands by until the digest watching is requested, and if there is the digest watching request (the step A10: YES), the CPU 211 judges whether or not the digest data about the requested content is stored on the HDD 240 (step All).

On the recording/reproducing apparatus 200, the digest data which is once generated by the digest data generation device 250 is stored on the HDD 240 in such a form that the digest data is associated with the corresponding content. That is, the recording/reproducing apparatus 200 is adapted to quickly perform digest watching with respect to the content in which the digest data has been generated once. If the digest data is stored (the step All: YES), the CPU 211 transits the process to a step A16.

On the other hand, if the digest data is not stored (the step All: NO), the CPU 211 requests the segment information about the content from the information providing server 100 (step A12). At this time, as the entry to request the segment information corresponding to the content, a request signal is transmitted to the information providing server 100.

On the information providing server 100, the CPU 110 searches for the content requested by the recording/reproducing apparatus 200 on the basis of the request signal. At this time, the segment information DB 121 is searched, and if a plurality of segment information 121 is set for the relevant content, i.e. if a plurality of keywords are set, the CPU 110 of the information providing server 100 transmits a list of the segment information 121a which can be supplied with regard to the relevant content, to the recording/reproducing apparatus 200.

On the recording/reproducing apparatus 200 side, one keyword is selected from the list by the user 200A and is transmitted again to the information providing server 100 as an entry which indicates the selection. In response to the entry, the CPU 110 selects the segment information 121a about the selected keyword, from the segment information DB 121.

Moreover, the CPU 110 judges whether or not there is the segment set by the watching support information 122a in the segments defined by the selected segment information 121a. If there is such a segment, the CPU 110 further selects the corresponding watching support information 122a from the watching support information DB 122.

In this manner, eventually, the selected segment information 121a and the watching support information 122a are transmitted to the recording/reproducing apparatus 200 through the communication device 130.

On the recording/reproducing apparatus 200, after the segment information is requested, it is judged whether or not the segment information is received in constant timing (step A13). If the segment information (including the watching support information in this case) is not received (the step S13: NO), the CPU 211 repeats the process related to the step A13. Incidentally, in the embodiment, it is premised that at least one segment information 121a is prepared for each content; however, no segment information 121a is prepared depending on the content. In case of such a situation, the information providing server 100 may transmit information which indicates that no segment information is prepared, to the recording/reproducing apparatus 200 if the segment information is requested for the content in which the segment information is not prepared. Alternatively, in some cases, some communication failure freezes the process related to the step A13. In case of such a situation, a control time may be set in advance for the process related to the step A13. If such functions are provided, the process related to the step A13 may be ended by some reasons other than the reception of the segment information Incidentally, if no segment information is prepared or if some communication failure occurs, the CPU 211 may perform a process of returning the process to each of the step A10 and the step A12.

If the segment information 121a and the watching support information 122a are received (the step A13: YES), the CPU 211 controls the digest data generation device 250 on the basis of the received information to thereby generate the digest data (step A14). If not only the segment information but also the watching support information are supplied from the information providing server 100, the CPU 211 further corrects the digest data which is generated on the basis of the segment information, on the basis of the watching support information. The digest data generated in the step A14 is the digest data including that the correction is performed by the watching support information as described above.

If the digest data is generated, the CPU 211 stores the generated digest data onto the HDD 240 (step A15). At this time, the digest data is stored in such a form that the digest data is associated with the relevant content.

If the storage onto the HDD 240 is ended, the CPU 211 controls the recording/reproducing device 230 to make the display apparatus 13 display the digest which is based on the generated digest data (i.e. one example of the “corrected digest” of the present invention if the correction is performed on the basis of the watching support information) (step A16), and to release a sound about the digest from the speaker 14, to thereby end the digest watching process. The recording/reproducing apparatus 200 reproduces the digest of the content in this manner.

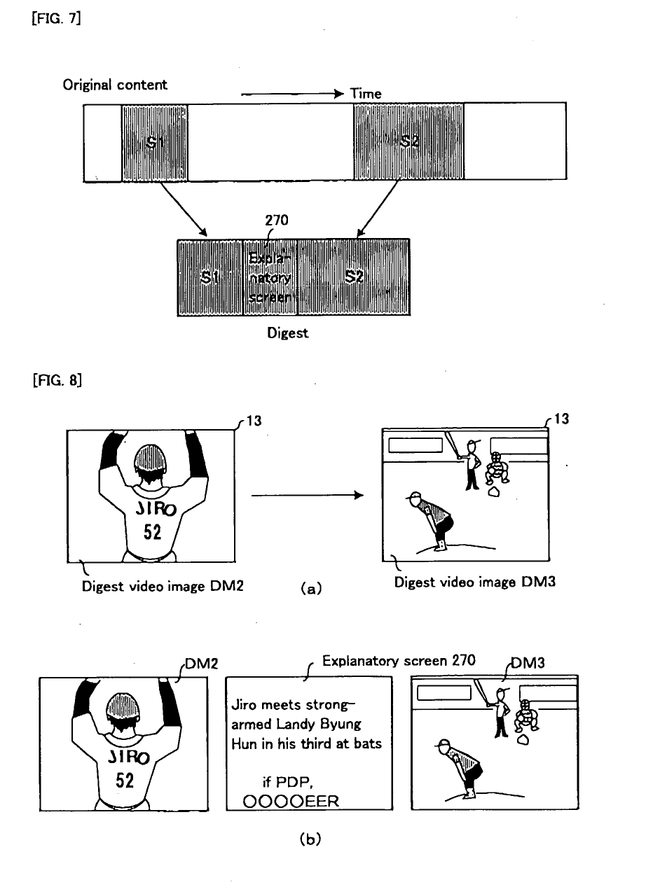

Now, with reference to FIG. 6, the details of the watching support information are explained. FIG. 6 are schematic diagrams showing digest video images which are corrected on the basis of the watching support information.

In FIG. 6, a digest video image DM1 before the correction based on the watching support information 122a is shown in FIG. 6(a). The digest video image DM1 is one scene of a baseball game live in which a player hit a home run.

On the other hand, in the corrected digest video image DM1 (FIG. 6(b)), an imposed video image 260 is displayed on the basis of the watching support information 122a. In this case, the watching support information 122a includes data for specifying a segment, display timing, a display time, a display position, a display color, font, or the like when the imposed video image 260 is displayed, in addition to the video data for displaying the imposed video image 260. The CPU 211 controls the digest data generation device 250 when correcting the digest data in the step A14 in FIG. 5 described above, and rewrites one portion of the digest data so as to realize the display of the imposed video image 260 specified by the watching support information 122a, to thereby correct the digest data.

In FIG. 6(b), the imposed video image 260 is a video image of a scoreboard at that time point. The user 200A does not always watch the content from the start, so even if the screen of the home run is merely displayed as shown in FIG. 6(a), the user 200A does not know a score state at that time point at all. The imposed video image 260 allows the user 200A to easily understand a run of play at that time point, to thereby dramatically improve satisfaction with the digest watching. That is, it allows the high-quality digest watching.

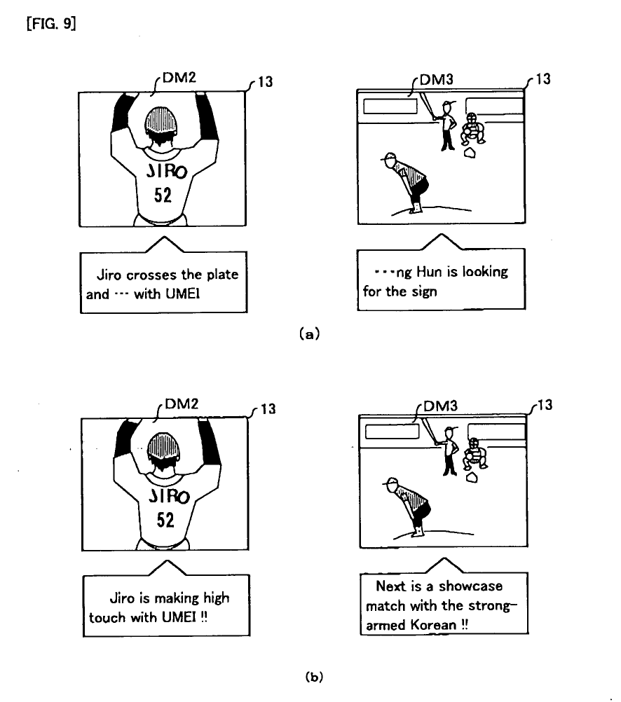

On the other hand, improving the quality of the digest video images, which is realized by the watching support information 122a, is not limited to the imposed video image 260. Now, with reference to FIG. 7 and FIG. 8, other digest video images based on the watching support information 122a are explained. FIG. 7 is a conceptual view showing the digest. FIG. 8 are schematic diagrams showing digest video images Incidentally, in these drawings, the same points as those in each of the drawings, which have already appeared, carry the same numerical references, and the explanation thereof will be omitted.

In FIG. 7, it is assumed that the segment S1 and the segment S2 are used for the digest from the original content. Here, the time-series arrangement is defined by the segment information 121a, and normally, the segment S2 is arranged after the segment S1 to construct the digest. However, using the watching support information 122a allows an explanatory screen to be inserted, as occasion demands, in the boundary of the segments which are merely arranged in time series. That is, the order of reproduction is the segment S1, an explanatory screen 270, and the segment S2.

FIG. 8 show the situation. FIG. 8(a) shows the digest which is not corrected by the watching support information in which a digest video image DM2, which is the video image of the segment S1, is reproduced before a digest video image DM3, which is the video image of the segment S2. In this case, the continuity of the video images is not concerned at all, and the user 200A merely watches pieces of the video images. In that respect, according to the digest video images corrected by the watching support information 122a, the explanatory screen 270 is inserted between the digest video images DM2 and DM3. The explanatory screen 270 allows the user 200A to understand the substance or content of the digest video image DM3 immediately before the digest video image DM3 is reproduced. Thus, the user can watch the segment S2, comfortably.

Incidentally, the watching support information 122a for inserting the explanatory screen 270 includes not only the video data of the explanatory screen 270 but also data or the like which defines the end position of the segment S1 and the start position of the segment S1.

Moreover, the explanatory screen 270 can also display an advertisement, as occasion demands. In FIG. 8(b), advertisement information is displayed in the lower part of the explanatory information 270.

Moreover, the watching support information 122a is not limited to the information which corrects the video images of the digest like the aforementioned two examples. Now, with reference to FIG. 9, other digests are explained on the basis of the watching support information 122a. Here FIG. 9 are schematic diagrams showing digest video images. Incidentally, in FIG. 9, the same points as those in FIG. 8 carry the same numerical references.

In FIG. 9, with regard to the digest video images, the digest video images DM2 and DM3 are shown. If no correction is made here, a digest sound tends to disturb the digest watching because it starts from the middle of a live commentary or ends in the middle of the live commentary, as shown in FIG. 9(a).

Thus, the watching support information 122a includes audio data which is replaced by audio information about the original content, in changing the segments By the operation of the watching support information 122a about the sound, the sound in changing the segments is replaced by the clear audio information (FIG. 9(b)). Such audio information does not have to be completely replaced by the original audio information as described above. In that case, one portion or all of the audio data of the content and the audio data included in the watching support information 122a may be combined.

As described above, the watching support information 122a allows the audio quality of the digest to be remarkably improved.

Incidentally, when the content is recorded onto the HDD 240, in some cases, the broadcasting of the content is possibly not started at a scheduled broadcast time point, depending on the situations of the broadcast station 12. In this case, if no measures are taken, the position of the segment on the content indicated by the segment information becomes different from the position of the segment related to the actually recorded content. If so, the correct digest video images are hardly reproduced. Thus, in the embodiment, segment change information is generated on the recording/reproducing apparatus side 200 to avoid such a problem.

Now, with reference to FIG. 10, the segment change information is explained. FIG. 10 is a schematic diagram showing the segment change information. Incidentally, in FIG. 10, the same points as those in FIG. 3 carry the same numerical references, and the explanation thereof will be omitted.

As illustrated, there is a difference by a delay time Δt between the broadcast schedule of the content which is scheduled to be broadcasted (upper part) and the schedule of the content which is actually broadcasted (lower part). That is, if the segment information 121a for specifying the segment S1 to be included in the digest is employed as it is, such a segment that is different from the segment S1 will be included in the digest.

In such a case, the segment change information is generated by the CPU 211 of the recording/reproducing apparatus 200. The segment change information is information for correcting the segment information 121a in view of the delay time Δt. As illustrated, a start time point (or relative time point) T1 of the segment information is changed to a start time point T1+Δt by using the segment change information. As described above, correcting the segment information by using the segment change information allows high-quality digest watching, even with regard to the content which is recorded when they are not broadcasted as scheduled for some reasons.

Incidentally, users (including the user 200A) of the recording/reproducing apparatus 200 have their own preferences, so some tendency appears when the users watch the digest in some cases. The recording/reproducing apparatus 200 can also recommend the digest to e.g. the user 200A, on the basis of each user's own preference. For example, as an aspect of judging each user's preference, the recording/reproducing apparatus 200 can judge the preference of the user 200A in the following approaches (1) to (3).

(1) Judge it from the entry by the user 200A

(2) Judge it from the selection history of the digest

(3) Judge it from the history of a trick play

In the case of (1), in addition to the entry results of the keyword, content, or the like, which are selected by the user 200A to watch the digest, even in the case that the user 200A watches e.g. the content which is merely recorded, that can be regarded as information for judging or determining the user's preference.

In the case of (2), it is also possible to judge the user's preference on the basis of the type and the number of the digest data stored on the HDD 240, or the history of the digest selected from the HDD 240.

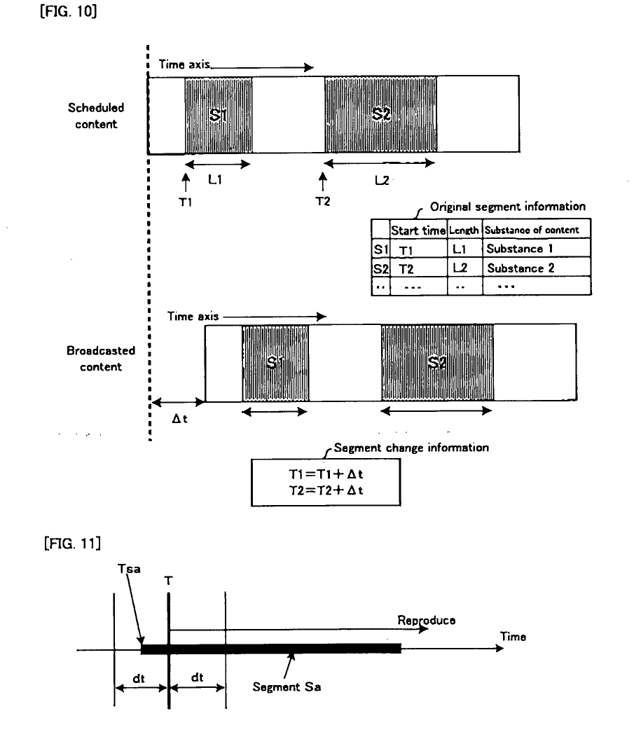

In the case of (3), the user's preference is judged on the basis of the history of the trick play, such as fast-forward reproduction and rewinding reproduction This will be explained with reference to FIG. 11. FIG. 11 is a schematic diagram showing the preference judgment based on the trick play.

In FIG. 11, the digest watched by the user 200A is shown with respect to a time axis. It is assumed that user 200A fast-forwards and starts to reproduce one scene T at a normal speed while watching the digest. If there is the start time point of some segment a time dt (e.g. about 15 seconds) before and after the scene T, the CPU 211 registers the keyword corresponding to the segment as the user 200A's preference information. Such a process is repeated to judge the user 200A's preference. For example, in FIG. 11, there is a start time point Tsa of a segment Sa before the scene T, and the segment Sa is considered to match the user's preference. Thus, the CPU 211 of the recording/reproducing apparatus 200 registers the keyword corresponding to the segment Sa as the user 200A's preference information into e.g. a predetermined area of the HDD 240, as needed. Such a process is repeated, and the number of registration for each keyword is counted. As a result of the count, the keyword in which the number of its registration is in the top is employed as the user's preference information.

Incidentally, if the content cannot be recorded correctly, for example, if the head or the tail is cut, there is sometimes a problem in the digest watching even if there is no problem in the normal reproduction. In such a case, for example, when receiving the list data of the keywords transmitted by the information providing server 100 to the recording/reproducing apparatus 200 in accordance with the digest watching request, the CPU 211 of the recording/reproducing apparatus 200 may not be able to select such a keyword that includes the segment in which the digest cannot be reproduced. Moreover, the CPU 211 may display information which indicates the reproduction incapability. Alternatively, the CPU 211 may perform such control that the CPU 211 notifies the fact that it is about to get to a portion that cannot be reproduced when that happens and that does not reproduce it. Alternatively, the CPU 211 may request data (or still image, simplified motion picture, or the like) for compensating a portion which is not correctly recorded, to the broadcast station 12 or the information providing server 100.

Incidentally, the recording/reproducing apparatus 200 may be adapted to receive an emergency broadcast signal. In this case, the recording/reproducing apparatus 200 may be adapted to always receive emergency broadcast, regardless of in the digest watching and in the normal reproduction. Alternatively, if the emergency broadcast is performed, the recording/reproducing apparatus 200 may display the fact on a screen in the digest watching or in the normal reproduction and receive the emergency broadcast signal under the agreement of the user 200A.

Incidentally, in the boundary between the segments, the discontinuity of a sound easily turns up. In such a case, as described above, the digest data may be corrected by using the watching support information 122a so as to reproduce a sound for digest watching. Except that, a sound may be faded out near the end of the segment, which is previous in time series out of the segments which are adjacent to each other, and a sound may be faded in near the start of the next segment, by which an uncomfortable feeling caused by the discontinuity may be reduced. Alternatively, if the sound pressure of the segment which comes later can be specified in advance, the sound pressure of the segment, which is reproduced before the aforementioned segment, may be adjusted in accordance with the sound pressure firstly mentioned.

Incidentally, during the digest watching, if it is desired to watch a previous scene and a next scene in the normal reproduction which is not the digest, the digest watching may be suspended or stopped and changed to the normal reproduction, as occasion demands, to allow the user to watch the scene. Such a changing aspect may be arbitrary as long as such a change can be performed. For example, a plurality of patterns may be set in advance, and one pattern may be selected by the user in accordance with the usability, or on the apparatus side at each time as an appropriate pattern, as occasion demands. For example, if it is requested to change to the normal reproduction during the digest watching, the digest reproduction may be continued until the end point of the segment during the digest watching, and the normal reproduction may be performed following the end point.

Moreover, in contrast, it is sometimes requested to change to the digest watching during the normal reproduction. In this case, there are two possible ways described below.

(1) If the change is in the period of some segment, the normal reproduction is performed until the end of the segment, and the digest watching is performed from the next segment.

(2) If the change is between segments, the digest watching is performed from the segment which is immediately after the change.

Of course, without being limited to the aforementioned two ways, the change may be performed in any aspects as long as the change can be performed from the normal reproduction to the digest watching.

Alternatively, during the digest watching, the digest reproduction may be performed by returning to the head of the segment or by skipping to the next or previous segment, for example, by the user's operation.

Incidentally, the segment in the change from the normal reproduction to the digest watching or in the change from the digest watching to the normal reproduction may include a screen which is inserted between the segments, such as the aforementioned explanatory screen 270.

Incidentally, a time point is displayed on a screen in some content. Since the digest watching is basically not performed for the content which is broadcasted in real time, such a time point display becomes disadvantageous in some cases. In such a case, the time point display may be hidden by using the same color as that of the background of a character for the time point display, or may be hidden by using another character. Moreover, the time point display may be gradated. Alternatively, it may be hidden by using a motion-compensated technique for motion-picture compression coding.

Incidentally, in the present invention, various changes may be made without departing from the essence or spirit of the invention which can be read from the claims and the entire specification. A digest watching system and a reproduction controlling apparatus for digest watching, which involve such changes, are also intended to be within the technical scope of the present invention.

### INDUSTRIAL APPLICABILITY

The digest watching system and the reproduction controlling apparatus for digest watching according to the present invention can be applied to a digest watching system to watch the digest of content and a reproduction controlling apparatus for digest watching.

1. A digest watching system comprising: a server apparatus; and a reproduction controlling apparatus, which are both included in a network,
said server apparatus comprising:
a first memory device for storing specification data, which is to specify segments corresponding to a keyword which is set in advance in content including at least a video image, in association with the keyword;
a second memory device for storing support data, which is to support watching of at least one portion of the segments corresponding to the keyword, in association with the at least one portion of the segments;
a selecting device for selecting the specification data and the support data which correspond to at least one of the content and the keyword which is specified, in accordance with an entry which indicates the specification of at least one of the content and the keyword; and
a first communicating device for transmitting the selected specification data and the selected support data to said reproduction controlling apparatus through the network,
said reproduction controlling apparatus comprising:
a third memory device for storing the content;
a second communicating device for receiving the transmitted specification data and the transmitted support data through the network;
a digest data generating device for generating digest data which is to generate a digest of the content in which the segments corresponding to the keyword, which are specified by the received specification data, are arranged in time series, out of the stored content;
a digest data correcting device for correcting at least one portion of the digest data on the basis of the received support data; and
a reproducing device for reproducing the digest which is corrected, on the basis of the corrected digest data.

2. The digest watching system according to claim 1, wherein
the support data includes data which defines an imposed video image to be imposed on the at least one portion of the segments, and
said digest data correcting device corrects the digest data so as to impose the imposed video image on the at least one portion of the segments, in the corrected digest, on the basis of the data which defines the imposed video image.

3. The digest watching system according to claim 1, wherein
the support data includes data which defines an explanatory video image for explaining substance of the at least one portion of the segments, and
said digest data correcting device corrects the digest data so as to reproduce the explanatory video image before reproducing the at least one portion of the segments, in the corrected digest, on the basis of the data which defines the explanatory video image.

4. The digest watching system according to claim 1, wherein
the content includes a sound,
the support data includes audio correction data for correcting a sound of the at least one portion of the segments, and
said digest data correcting device corrects the digest data so as to correct the sound of the at least one portion of the segments, in the corrected digest, on the basis of the audio correction data.

5. A reproduction controlling apparatus for digest watching, capable of communicating through a network with a server apparatus comprising: a first memory device for storing specification data, which is to specify segments corresponding to a keyword which is set in advance in content including at least a video image, in association with the keyword; a second memory device for storing support data, which is to support watching of at least one portion of the segments corresponding to the keyword, in association with the at least one portion of the segments; a selecting device for selecting the specification data and the support data which correspond to at least one of the content and the keyword which is specified, in accordance with an entry which indicates the specification of at least one of the content and the keyword; and a first communicating device for transmitting the selected specification data and the selected support data to said reproduction controlling apparatus through the network, said reproduction controlling apparatus comprising:
a third memory device for storing the content;
a second communicating device for receiving the transmitted specification data and the transmitted support data through the network;
a digest data generating device for generating digest data which is to generate a digest of the content in which the segments corresponding to the keyword, which are specified by the received specification data, are arranged in time series, out of the stored content;
a digest data correcting device for correcting at least one portion of the digest data on the basis of the received support data; and
a reproducing device for reproducing the digest which is corrected, on the basis of the corrected digest data.
